(19) United States
(12) Patent Application Publication
(10) Pub. No.: US 2009/0223131 A1
(43) Pub. Date: Sep. 10, 2009

(54) STEEL FRAME WOOD PANEL GARAGE DOOR

(76) Inventor: PAUL A. WIESE, Yucca Valley, CA (US)

Correspondence Address: STETINA BRUNDA GARRED & BRUCKER, 75 ENTERPRISE, SUITE 250, ALISO VIEJO, CA, 92656, US

(21) Appl. No.: 12/042,569

(22) Filed: Mar. 5, 2008

(51) Int. Cl. E05D 15/38

(52) U.S. Cl. 49/197; 49/506

(57) ABSTRACT

There is provided a garage door comprising a front panel including a plurality of front panel members. Each front panel member defines panel member front and rear surfaces. The garage door also includes a plurality of frame assemblies. Each frame assembly is connected to a panel member rear surface. Each frame assembly includes a pair of rails and a plurality of stiles. Each rail includes a rail inner surface. The rail inner surfaces are disposed in opposed relation to each other. Each stile includes opposing end surfaces and a opposing stile inner surfaces. Each stile end surface is attached to a rail to form a plurality of frame opening peripheries. The garage door additionally includes a plurality of fasteners connect the frame assemblies to the front panel members. Pivot members are connected to adjacent ones of the plurality of frame assemblies to enable pivotal movement therebetween.

### CROSS-REFERENCE TO RELATED APPLICATIONS

(Not Applicable)

### STATEMENT RE FEDERALLY SPONSORED RESEARCH/DEVELOPMENT

(Not Applicable)

### BACKGROUND OF THE INVENTION

1. Field of the Invention

The present invention relates generally to garage doors and more particularly, to a garage door having a plurality of front panel members and a plurality of frame assemblies, each frame assembly connected to a respective one of a plurality of front panel members.

2. Description of the Related Art

Garages are commonly used to provide storage space for both residential and commercial buildings. Although garages may be used for storage of a wide range of items (e.g., tools, seasonal equipment, etc.), many garages are primarily used for storage of a vehicle. It is common for garages to include a garage door which may be opened to provide access into the garage from the outside environment. Garage doors are typically large to allow for the ingress and egress of vehicles into and out of the garage. Garage doors may also be employed to protect the inside of the garage, and items contained therein, from the natural elements such as rain, snow, and flying debris. When closed, the garage door may also provide security by restricting access into the inside of the garage. Garage doors may be configured to easily move between open and closed positions to allow easy access into and out of the garage. A typical garage door is opened by moving it upwardly into its open position. Most doors are maintained in the open position until they are acted upon to close. Some garage doors are manually opened, while other garage doors employ the assistance of a garage door opener. A garage door may be comprised of a single large panel, while others include a series of interconnected, smaller panels which collectively comprise the garage door.

Many garage doors are constructed from a metal material. Metal tends to be a very durable material that is capable of withstanding the environmental elements as well as the repeated uses thereof. However, given that garage doors tend to be very large, and commonly face the front of the residential structure, it may be desirable for the garage door to have aesthetically pleasing attributes. As such, many doors incorporate designs to improve the aesthetic quality thereof. With regard to metal garage doors, various designs may be stamped into the exterior surface of the door to improve the appearance of the same. In addition, windows and other features may also incorporated into the garage door to enhance its aesthetic appeal.

Although metal may be a preferable material because of its cost and ease of manufacture, other materials may prove to be more aesthetically pleasing. For instance, wood is a material that is commonly used in the construction industry because of its durability as well as its desirable appearance. Consequently, it may be desirable to incorporate wood into the design of the garage door in order to improve the aesthetic quality of the door. However, the structural integrity of the door may decrease, while the ease and cost of manufacture may increase in order to include wood within the garage door. Furthermore if the door is comprised of multiple panels, interruption of the natural design of the wood grain may decrease the overall aesthetics of the door. In addition, it may be difficult to incorporate windows and other design features into a wood door.

As is apparent from the foregoing, there exists a need in the art for a garage door including a strong, durable frame to which an aesthetically pleasing panel such as wood may be attached to. The present invention addresses this particular need, as will be described in more detail below.

### BRIEF SUMMARY OF THE INVENTION

There is provided a garage door comprising a front panel including a plurality of front panel members. Each front panel member defines a panel member front surface and a panel member rear surface. The garage door further includes a plurality of frame assemblies connected to the front panel. Each frame assembly is connected to the panel member rear surface of a respective one of the plurality of front panel members. Each frame assembly includes a pair of rails and a plurality of stiles. Each rail includes a rail inner surface, wherein the rail inner surfaces of the pair of rails are disposed in opposed relation to each other. Each stile includes a pair of opposing stile end surfaces and a pair of opposing stile inner surfaces. Each one of the pair of opposing stile end surfaces is attached to a respective one of the pair of rails to form a plurality of frame opening peripheries. Each frame opening periphery is defined by the opposing rail inner surfaces and the opposing stile inner surfaces of adjacent stiles. The garage door additionally includes a plurality of fasteners. Each fastener connects a respective one of the plurality of frame assemblies to a respective one of the plurality of front panel members. The garage door further includes a plurality of pivot members. Each pivot member is connected to adjacent ones of the plurality of frame assemblies to enable pivotal movement between the same.

The garage door of the present invention may provide a structurally sound and aesthetically pleasing garage door. The front panel may be comprised of a wood material to enhance the aesthetic quality of the door. Furthermore, various aesthetic designs may be incorporated into the front panel to enhance the appearance thereof. The frame assemblies included in the garage door provide a rigid framework to which the front panel may be securely attached to. It is contemplated that the frame assemblies may be constructed of a strong, rigid material such as steel.

The front panel members of the garage door may include a panel member top surface and a panel member bottom surface. At least one of the panel member top surfaces and the panel member bottom surfaces may be non-orthogonal to the panel member front surface. At least one of the plurality of front panel members may include a panel member top surface and a panel member bottom surface that is non-orthogonal to the panel member front surface. The non-orthogonal orientation of the panel member top and/or bottom surfaces may allow adjacent front panel members to intersect along a non-orthogonal angle to the panel member front surface, which tends to mitigate outside elements such as water from passing through the garage door.

Furthermore, the frame assembly may include powder/coated rails and stiles to mitigate the formation of rust thereon. Furthermore, the opposing stile end surfaces may be attached to a respective one of the pair of rails by a butt joint. The butt joint may enhance the structural integrity of the frame assembly.

Each frame assembly may also include a plurality of affixing members. Each affixing member may be connected to a respective one of the plurality of frame opening peripheries. Each fastener may connect a respective one of the plurality of affixing members to the respective one of the plurality of front panel members. Each frame assembly may include a frame assembly front surface, and each affixing member may include an affixing member front surface. The affixing member front surface may be offset from the frame assembly front surface by 1/16 of an inch.

An aspect of the present invention additionally includes a method of forming a garage door. The method includes the steps of providing a front panel having a front panel rear surface, a plurality of rails and a plurality of stiles. The method also includes the step of constructing a plurality of frame assemblies by attaching multiple ones of the plurality of stiles between a pair of the plurality of rails. The opposing stile end surfaces are attached to a respective one of the rail inner surfaces to form a plurality of frame opening peripheries. The plurality of frame assemblies are then disposed adjacent the front panel rear surface. Adjacent ones of the plurality of frame assemblies are spaced apart to define a cutting channel. The plurality of frame assemblies are then fastened to the front panel. The front panel is then cut along each cutting channel. Adjacent ones of the plurality of frame assemblies are then connected with at least one pivot member to enable pivotal movement between the respective frame assemblies.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a front, top perspective view of a garage door constructed in accordance with an aspect of the present invention;

FIG. 2 is a rear top perspective view of the garage door illustrated in FIG. 1;

FIG. 3 is a side elevation view of the garage door illustrated in FIG. 1;

FIG. 4 is an exploded view of a frame assembly;

FIG. 5 is a top perspective view of the frame assembly;

FIG. 6 is a top perspective view of the frame assembly illustrated in FIG. 5, further including a plurality of affixing members;

FIG. 7 is a side sectional view of the frame assembly illustrated in FIG. 6;

FIG. 8 is a front, sectional elevation view of the frame assembly illustrated in FIG. 6;

FIG. 9 is an exploded view of a plurality of frame assemblies and a front panel;

FIG. 10 is a rear elevation view of the plurality of frame assemblies connected to the front panel;

FIG. 11 is a side elevation view of the plurality of frame assemblies and front panel as shown in FIG. 10, the front panel being cut along a plurality of cutting axes, each cutting axis forming an angle φ with a front panel rear surface;

FIG. 12 is a top perspective view illustrating a plurality of filler members disposed within a frame assembly;

FIG. 13 is a top cutaway perspective view of a frame assembly having a window box disposed within a frame periphery, the front panel defining a window opening between the plurality of affixing members;

FIG. 14 is a top cutaway perspective view of a frame assembly having a plurality of window backstops disposed within the frame periphery adjacent the window opening;

FIG. 15 is a top cutaway perspective view of a frame assembly having a window box disposed within a frame periphery, the front panel including a front panel window cutout defining a cutout window opening; and

FIG. 16 is a top cutaway perspective view showing a prefabricated window disposed within a window opening formed within the front panel.

### DETAILED DESCRIPTION OF THE INVENTION

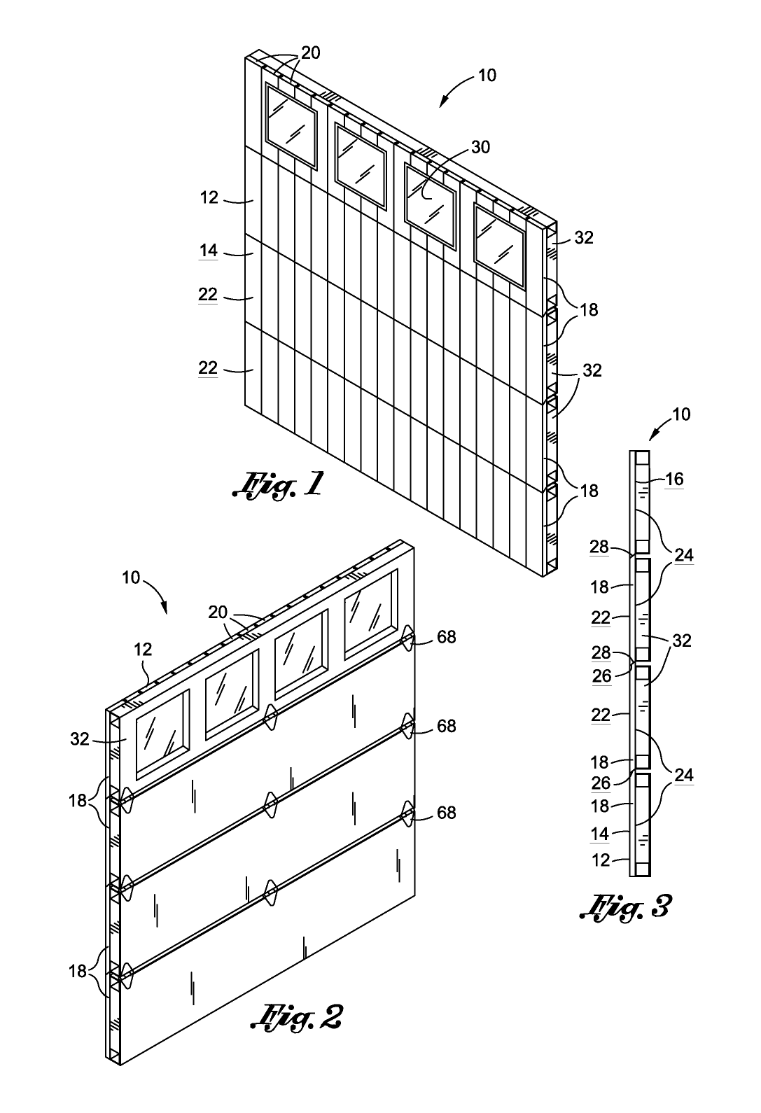

Referring now to the drawings wherein the showings are for purposes of illustrating a preferred embodiment of the present invention only, and not for purposes of limiting the same, there is shown a garage door 10 constructed in accordance with an aspect of the present invention. Referring specifically to FIG. 1-3, the garage door 10 includes a front panel 12 connected to a plurality of frame assemblies 32. The front panel 12 defines a front panel forward surface 14 and a front panel rear surface 16. The front panel 12 may be formed of a plurality of panel elements 20. The panel elements 20 may be constructed out of a variety of materials, including wood, plywood, tongue and groove (e.g., cedar, knotty pine), or other materials known by those skilled in the art. As depicted in FIG. 1, the front panel 12 is constructed out of a plurality of tongue and groove members that engage with each other to collectively define the front panel 12. In one embodiment, each panel element 20 is ⅝ inch in width.

The front panel 12 may be cut into several front panel members 18. The process of cutting the front panel 12 into the front panel members 18 is described in more detail below. Each front panel member 18 defines a panel member front surface 22, a panel member rear surface 24, a panel member top surface 26, and a panel member bottom surface 28.

Referring now to FIGS. 4-5, the garage door 10 additionally includes a plurality of frame assemblies 32. Each frame assembly 32 is connected to the panel member rear surface 24 of a respective one of the plurality of front panel members 18. Each frame assembly 32 includes a pair of rails 36 disposed in spaced parallel relation to each other. Each rail 36 includes a rail inner surface 38. The rail inner surfaces 38 are disposed in opposed relation to each other.

Each frame assembly 32 also includes a plurality of stiles 46. Each stile 46 includes a pair of opposing stile end surfaces 48, a pair of opposing stile inner surfaces 50, a stile forward surface 52 and a stile rear surface 54. Each one of the pair of opposing stile end surfaces 48 is attached to a respective one of the pair of rails 36 to form a plurality of frame opening peripheries 56. As shown, the stile end surfaces 48 are connected to the rail inner surface 38 of a respective rail 36. Each frame opening periphery 56 is defined by the opposing rail inner surfaces 38 and the opposing stile inner surfaces 50 of adjacent stiles 46. Each frame opening periphery 56 defines a frame opening 58. Windows 30 and other aesthetic elements may be disposed within the frame opening 58, as described in more detail below.

According to one embodiment, the rails 36 and stiles 46 may be constructed out of a steel material. For instance, the rails 36 and stiles 46 depicted in the figures are comprised of hollow, square and rectangular, steel tubing. However, it is understood that other materials and configurations known by those skilled in the art may be used without departing from the spirit and scope of the present invention.

The rails 36 and stiles 46 may be joined by welded joints. In one embodiment, the stiles 46 may be joined to the rails 36 by a butt joint. However, other joining techniques known by those skilled in the art, such as a bevel joint, may also be used. The rails 36 and stiles 46 are completely welded and sealed to mitigate the formation of rust. Once the rails 36 are joined to the stiles 46, all seams may be ground smooth to provide a smooth surface.

In order to enhance the structural integrity of each frame assembly 32 and to lengthen the life span thereof, additional measures may be taken to protect against rust forming on the frame assembly 32. In order to protect against rust formation, the rails 36 and/or the stiles 46 may be powder coated. Various colors of powder coating may be applied to the rails 36 and stiles 46 in order to match the color of the frame assembly 32 with the remaining portions of the garage door 10.

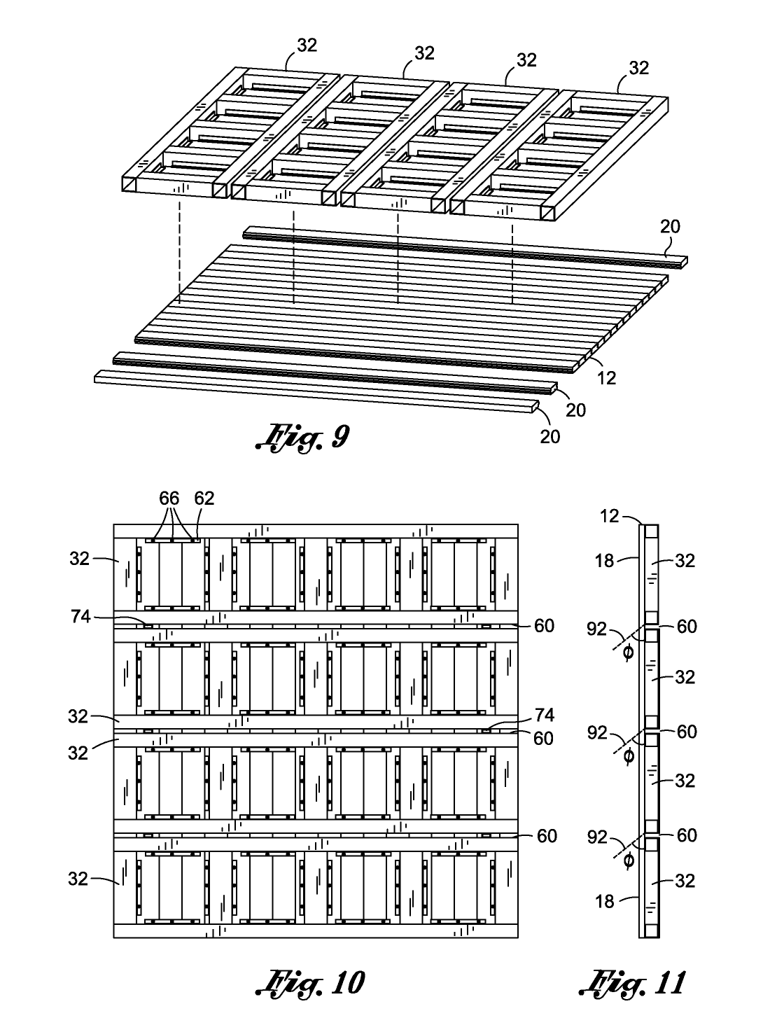

Each frame assembly 32 is connected to a respective one of the plurality of front panel members 18. In order to facilitate this connection, each frame assembly 32 may include a plurality of affixing members 62 as best shown in FIG. 6. Each affixing member 62 may be connected to a respective one of the plurality of frame opening peripheries 56. In one embodiment, four affixing members 62 are connected to each frame opening periphery 56; one on each opposing stile inner surface 50 and one on each opposing rail inner surface 38. In one embodiment, the affixing members 62 are comprised of flashing, as best shown in FIGS. 6-8. The flashing may be constructed out of twenty six gauge aluminum steel. The flashing may be welded to the frame opening periphery 56. The flashing may be welded every eight inches to securely fasten it to the frame opening periphery 56. However, other securing techniques known in the art may also be used. Furthermore, each affixing member 62 may be powder-coated to mitigate rust formation thereon, as described above in relation to the frame assembly 32.

According to one embodiment, the frame assembly 32 defines a frame assembly front surface 34. Likewise, the affixing member 62 defines an affixing member front surface 64. One aspect of the present invention includes offsetting the affixing member front surface 64 from the frame assembly front surface 34 by a distance “d.” In one embodiment, the distance d is equal to 1/16 of an inch. The offset allows the affixing member 62 to be pulled toward the panel member rear surface 24 when the affixing member 62 is attached to the front panel member 18.

The garage door 10 further includes a plurality of fasteners 66 to connect a respective one of the plurality of frame assemblies 32 to a respective one of the plurality of front panel members 18. The fasteners 66 may connect the affixing members 62 to a respective front panel member 18. In one implementation of the present invention, the fasteners 66 include Number 8, ⅝ inch hex head self tapping screws. It may be desirable to use a screw every two inches to securely fasten the frame assembly 32 to the front panel member 18.

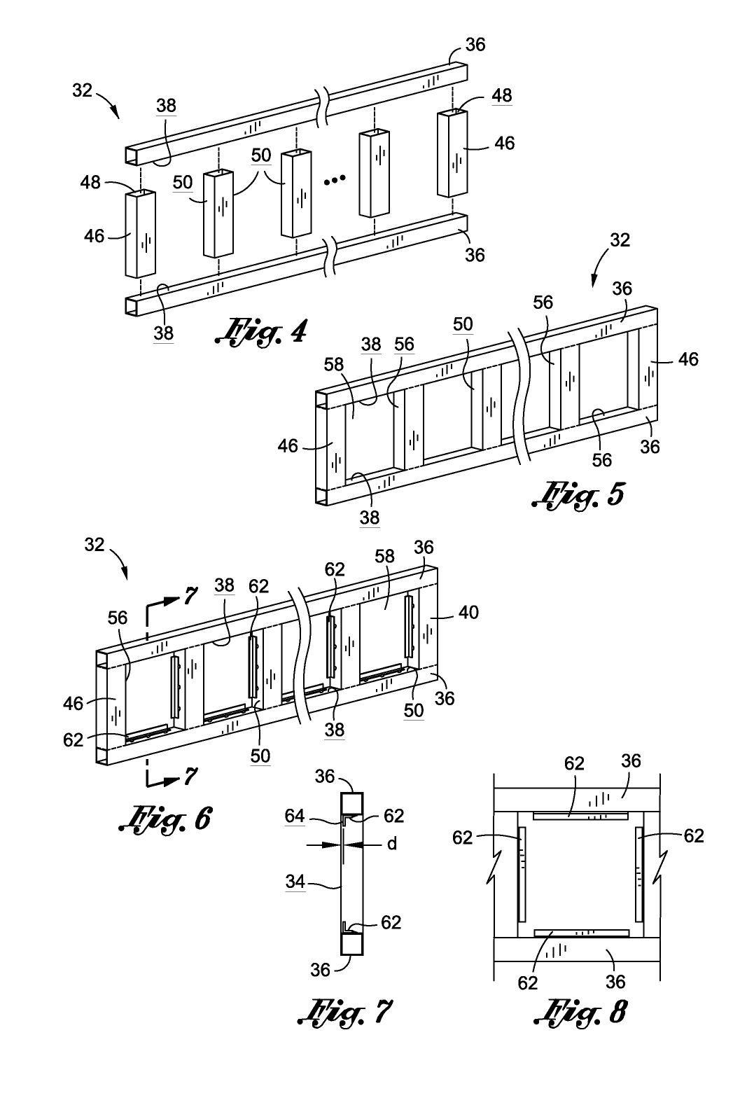

Each frame assembly 32 may be connected to the front panel 12 in such a manner so as to define a space between adjacent frame assemblies 32 as depicted in FIG. 3. This space defines a cutting channel 60 to allow the front panel 12 to be cut into separate front panel members 18, as described in more detail below.

The garage door 10 may include a plurality of filler members 70 disposed within respective frame openings 58. Each filler material 70 may be constructed out of Styrofoam or other insulating material. The filler member 70 may provide thermal insulation as well as sound insulation. In one implementation of the invention, each filler member 70 is comprised of 1¾ inch Styrofoam® and is inserted into each frame opening 58. The filler member 70 defines a filler member periphery that is smaller than the frame opening periphery 56. It may be desirable to have a ½ inch gap between the filler member periphery and the frame opening periphery 56 to allow for easy insertion of the filler member 70 into the frame opening periphery 56. In other embodiments, the filler members 70 are sized and configured to be press-fit into the frame opening periphery 56 and maintained in place via frictional contact between the filler member 70 and the frame opening periphery 56.

The filler members 70 may be maintained within the frame opening 58 by a rear panel member 72 that is connected to the frame assembly 32. The rear panel member 72 may include a ¼ inch Luan panel covering each filler member 70 within a respective frame assembly 32. The rear panel member 72 may be connected to the frame assembly 32 by a plurality of ½ inch self tapping truss screws. It may be desirable to use one screw every four inches to securely fasten the rear panel member 72 to the frame assembly 32.

As previously mentioned, the garage door 10 may include a various aesthetic features to enhance the appearance thereof. Windows 30 are commonly incorporated into the design of a garage door 10 to enhance its aesthetic quality. It is contemplated that the window 30 may fit within the frame opening 58 of the frame assembly 32. Referring now to FIG. 13, there is shown a garage door 10 having a window 30 that fits between the affixing members 62. A window opening 76 is cut out of the front panel 12 between the affixing members 62. A window box 78 is constructed and inserted within the respective frame opening 58. According to one aspect of the invention, the window box 78 defines a window box periphery 79 that is ⅛ of an inch larger than the window opening 76. The window 30 may be placed within the window box 78 and the ⅛ inch edge may act as a stop to prevent the window 30 from passing through the window opening 76.

It is contemplated that the window box 78 is assembled from a plurality of window box elements 80. The window box elements 80 may include 1 ½ inch by ⅝ inch lumber having slots which matingly engage with one another to form the window box 78 as shown in FIG. 13. One or more window back stops 82 may be inserted behind the window 30 to maintain the window 30 in place.

It is also contemplated that the garage door 10 may include a window 30 that may not fit between the affixing members 62. In such an embodiment, the affixing members 62 are removed from the respective frame opening periphery 56, or never attached thereto. A front panel window cutout 84 is removed from the front panel 12, as shown in FIG. 15. The front panel window cutout 84 includes a cutout window opening 86. A window box 78 is placed within the frame opening 58. As described above, the window box periphery 79 is slightly larger than the cutout window opening 86 to provide a small edge which acts as a glass stop. It is contemplated that the front panel window cutout 84 may be connected to the frame assembly front surface 34 to maintain the front panel window cutout 84 in its proper position. For instance, connections members, such as screws, nails, rivets, etc., may be used to connect the front panel window cutout 84 to the frame assembly 32. In another embodiment, the front panel window cutout 84 may be connected to adjacent portions of the front panel 12 to maintain the front panel window cutout 84 in its desired position.

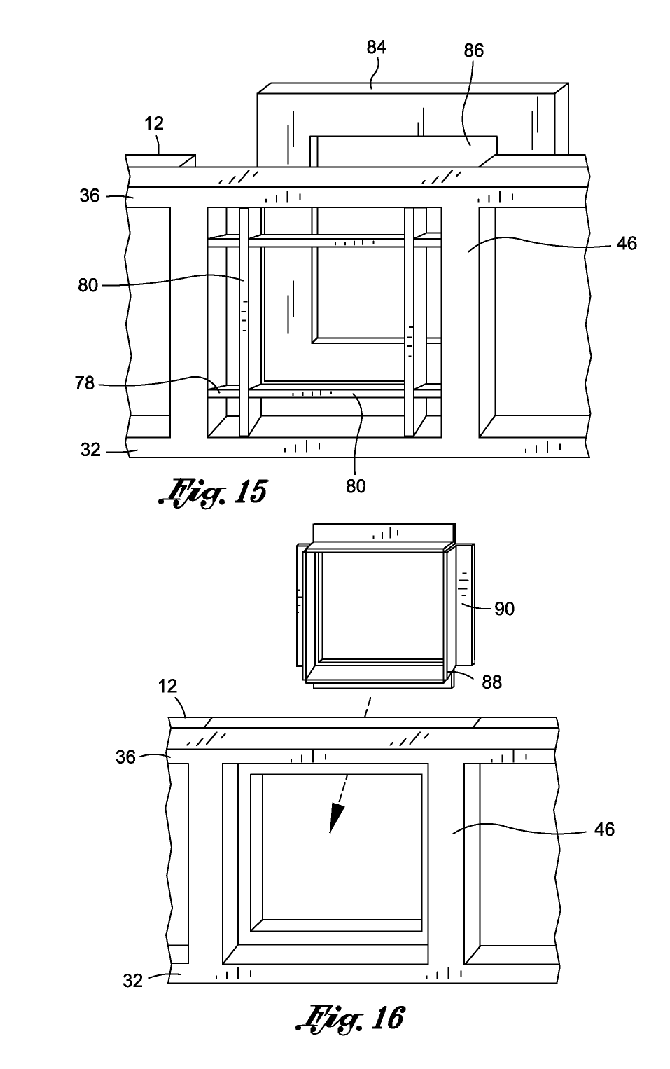

It is contemplated that for larger windows 30 a window box 78 may not be needed. In the embodiment shown in FIG. 14, the window 30 is large enough to fit within the frame opening 58 without a window box 78. As shown, a front panel window cutout 84 includes a cutout window opening 86 which is slightly smaller than the frame opening periphery 56. In one embodiment, such a cutout window opening 86 is ⅞ of an inch smaller than the frame opening periphery 56. Therefore, windows 30 that are larger than the cutout window opening 86, but smaller than the frame opening periphery 56 may be placed within the frame opening periphery 56. A plurality of window backstops 82 may be placed behind the window 30 to maintain the window 30 in place. Each window backstop 82 may be secured to the frame assembly 32.

Referring now to FIG. 16, there is shown a garage door 10 configured to receive a prefabricated window frame 88. A front panel window cutout 84 may be removed from the front panel 12 to create a cutout window opening 86 into which a prefabricated window frame 88 may be inserted into. In this manner, the affixing members 62 connected to the respective frame opening periphery 56 may be removed to allow the front panel window cutout 84 to be detached from the front panel 12. The front panel window cutout 84 may be secured to the frame assembly front surface 34. The cutout window opening 86 may be slightly larger than the prefabricated window frame 88 to allow the prefabricated window frame 88 to be inserted therein. The prefabricated window frame 88 may include frame flanges 90 to enable easy attachment of the prefabricated window frame 88 to the front panel window cutout 84.

The garage door 10 may further include a plurality of pivot members 68 to enable pivotal movement between adjacent front panel members 18. Each pivot member 68 is connected to adjacent ones of the plurality of frame assemblies 32 to enable pivotal movement between the same.

In addition to the foregoing, it is expressly contemplated that various aspects of the present invention additionally include a method of forming a garage door 10. The method includes the steps of providing a front panel 12 having a front panel rear surface 16. A plurality of rails 36 and stiles 46, as described in more detail above, are also provided. The plurality of frame assemblies 32 are constructed from the rails 36 and stiles 46. Each frame assembly 32 is constructed by attaching multiple ones of the plurality of stiles 46 between a pair of the plurality of rails 36. The opposing stile end surfaces 48 are attached to a respective one of the rail inner surfaces 38 to form a plurality of frame opening peripheries 56. The frame assemblies 32 may include affixing members 62 as described in more detail above. The affixing member front surface 64 may be offset from the frame assembly front surface 34 by a distance of 1/16 of an inch.

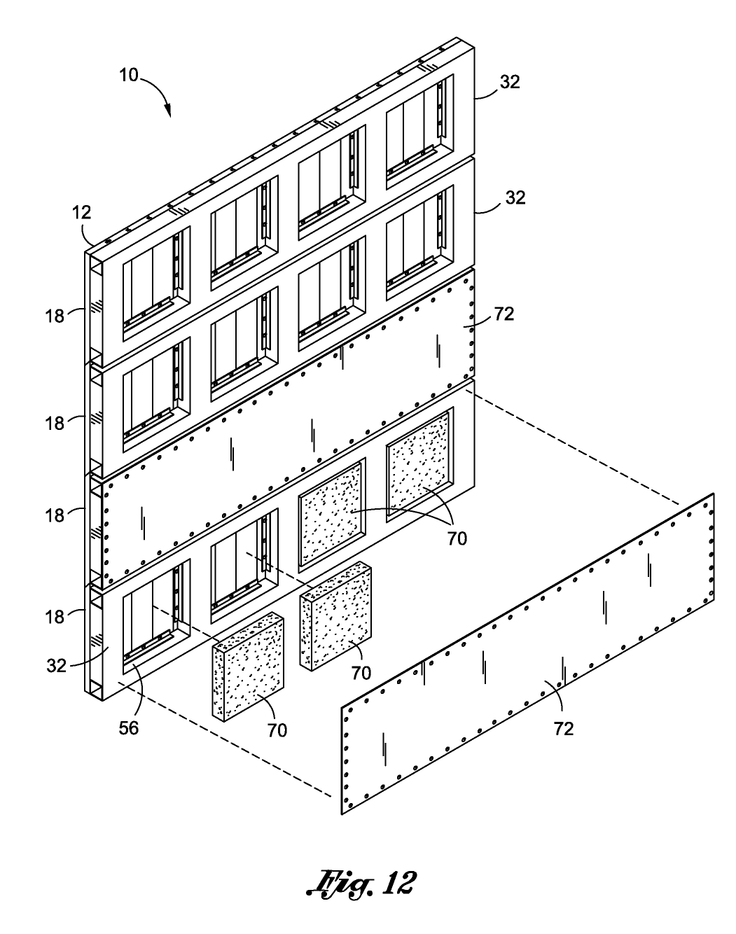

The frame assemblies 32 are then disposed adjacent the front panel rear surface 16, as best shown in FIG. 9. Adjacent frame assemblies 32 are spaced apart to define a cutting channel 60. One or more shims 74 may be disposed between adjacent frame assemblies 32 to create the cutting channel 60 between the adjacent frame assemblies 32. The frame assemblies 32 may be fastened to the front panel 12. In this manner, a respective fastener 66 may connect an affixing member 62 to the front panel rear surface 16. The offset between the affixing member front surface 64 and the frame assembly front surface 34 allows the affixing member front surface 64 to be drawn toward the front panel rear surface 16 as the fastener 66 connects the affixing member 62 to the front panel 12.

The method may also include the step of disposing filler members 70 within the frame openings 58 of the frame assemblies 32. A rear panel member 72 may be connected to the frame assembly 32 to maintain the filler members 70 within the respective frame opening 58.

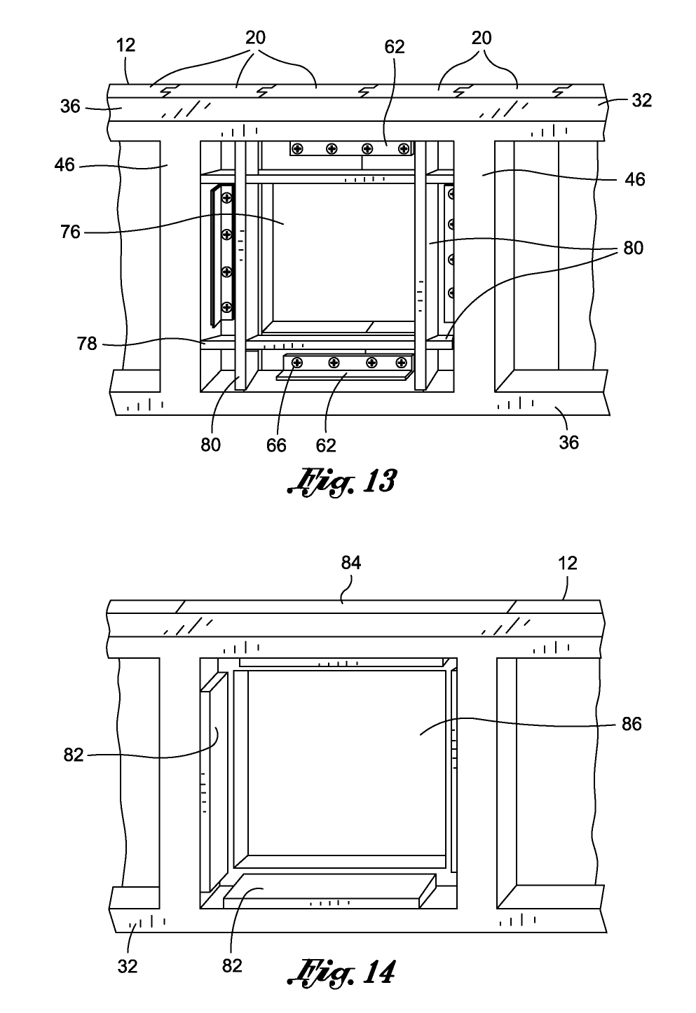

After the frame assemblies 32 have been connected to the front panel 12, the front panel 12 is cut along each cutting channel 60 to separate the front panel 12 into separate front panel members 18. It may be desirable to cut the front panel 12 at a non-orthogonal angle φ to the front panel rear surface 16, as shown in FIG. 11. In this manner, the panel member top surface 26 and/or the panel member bottom surface 28 is non-orthogonal to the panel member rear surface 24. The front panel 12 may be cut along the cutting channel 60 along a cutting axis 92. The cutting axis 92 may be non-orthogonal to the front panel rear surface 16. In one embodiment, the cutting axis 92 is disposed approximately 70 degrees relative to the front panel rear surface 16. The non-orthogonal orientation of the panel member top surface 26 and/or the panel member bottom surface 28 may mitigate natural elements from entering the garage. For instance, this unique angular engagement of the panel member bottom surface 28 of one front panel member 18 with the panel member top surface 26 of an adjacent front panel member 18 may further insulate the garage.

The method may also include connecting adjacent ones of the plurality of frame assemblies 32 with at least one pivot member 68 to enable pivotal movement between the respective frame assemblies 32. Windows 30 may also be incorporated into the garage door 10, as described in more detail above.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A garage door comprising:
a front panel including a plurality of front panel members, each front panel member defining a panel member front surface and a panel member rear surface;
a plurality of frame assemblies, each frame assembly connected to the panel member rear surface of a respective one of the plurality of front panel members, each frame assembly including:
a pair of rails, each rail having a rail inner surface, the rail inner surfaces being disposed in opposed relation to each other; and
a plurality of stiles, each stile having a pair of opposing stile end surfaces and a pair of opposing stile inner surfaces, each one of the pair of opposing stile end surfaces being attached to a respective one of the pair of rails to form a plurality of frame opening peripheries, each frame opening periphery being defined by the opposing rail inner surfaces and the opposing stile inner surfaces of adjacent stiles;
a plurality of fasteners, each fastener connecting a respective one of the plurality of frame assemblies to a respective one of the plurality of front panel members; and
a plurality of pivot members, each pivot member being connected to adjacent ones of the plurality of frame assemblies to enable pivotal movement between the adjacent ones of the plurality of frame assemblies.

2. The garage door as recited in claim 1, wherein each front panel member includes a panel member top surface and a panel member bottom surface, at least one of the panel member top surface and the panel member bottom surface being non-orthogonal to the panel member front surface.

3. The garage door as recited in claim 2, wherein the panel member top surface and the panel member bottom surface of at least one of the plurality of front panel members is non-orthogonal to the panel member front surface.

4. The garage door as recited in claim 1, wherein each frame assembly is powder-coated.

5. The garage door as recited in claim 1, wherein each one of the pair of opposing stile end surfaces is attached to a respective one of the pair of rails by a butt joint.

6. The garage door as recited in claim 1 wherein each frame assembly includes a plurality of affixing members, each affixing member being connected to a respective one of the plurality of frame opening peripheries, wherein each fastener connects a respective one of the plurality of affixing members to the respective one of the plurality of front panel members.

7. The garage door as recited in claim 6 wherein each frame assembly includes a frame assembly front surface and each affixing member includes an affixing member front surface, the frame assembly front surface being offset from the affixing member front surface by 1/16 of an inch.

8. The garage door as recited in claim 6 wherein the plurality of affixing members include flashing.

9. The garage door as recited in claim 1, further including a plurality of filler members, each filler member being disposed within a respective one of the plurality of frame opening peripheries.

10. The garage door as recited in claim 1 further comprising a plurality of rear panel members, each rear panel member being attached to a respective one of the plurality of frame assemblies.

11. The garage door as recited in claim 1 wherein adjacent ones of the plurality of frame assemblies are spaced apart by ⅛″.

12. The garage door as recited in claim 1 wherein at least one of the front panel members includes at least one window opening sized and configured to receive a window.

13. A method of forming a garage door, the method comprising the steps of:
(a) providing a front panel having a front panel rear surface, a plurality of rails and a plurality of stiles, each rail having a rail inner surface, each stile having a pair of opposing stile end surfaces and a pair of opposing stile inner surfaces;
(b) constructing a plurality of frame assemblies, each frame assembly being constructed by attaching multiple ones of the plurality of stiles between a pair of the plurality of rails, the opposing stile end surfaces being attached to a respective one of the rail inner surfaces to form a plurality of frame opening peripheries, each frame opening periphery being defined by the opposing rail inner surfaces and the opposing stile inner surfaces of adjacent stiles;
(c) disposing the plurality of frame assemblies adjacent the front panel rear surface, adjacent ones of the plurality of frame assemblies being spaced apart to define a cutting channel;
(d) fastening the plurality of frame assemblies to the front panel;
(e) cutting the front panel along each cutting channel; and
(f) connecting adjacent ones of the plurality of frame assemblies with at least one pivot member to enable pivotal movement being the respective frame assemblies.

14. The method as recited in claim 13 wherein step (f) includes cutting the front panel at a non-orthogonal angle relative to the rearward surface of the front panel.

15. The method as recited in claim 14 wherein the non-orthogonal angle is 70 degrees relative to the rearward surface of the front panel.

16. The method as recited in claim 13 wherein step (a) includes providing a plurality of powder-coated rails and a plurality of powder-coated stiles.

17. The method as recited in claim 13 wherein step (b) includes attaching the opposing stile end surfaces to a respective one of the rails inner surfaces by a butt joint.

18. The method as recited in claim 13 wherein step (b) includes attaching at least one affixing member to each frame opening periphery.

19. The method as recited in claim 18 wherein step (d) includes connecting each affixing member to the rearward surface of the front panel.

20. The method as recited in claim 13 wherein step (c) includes placing a shim between adjacent ones of the plurality of frame assemblies.
